(19) United States
(12) Patent Application Publication
(10) Pub. No.: US 2023/0032709 A1
(43) Pub. Date: Feb. 2, 2023

(54) COMPOSITE BUILDING MATERIAL

(71) Applicant: Nuevopoly LLC, Indianapolis, IN (US)

(72) Inventors: Jack Christy, Indianapolis, IN (US); Hector Escobar, Indianapolis, IN (US)

(21) Appl. No.: 17/863,354

(22) Filed: Jul. 12, 2022

Related U.S. Application Data
(63) Continuation-in-part of application No. 17/681,707, filed on Feb. 25, 2022.
Application No. 17/681,707 is a continuation-in-part of application No. 17/553,965, filed on Dec. 17, 2021.
(60) Provisional application No. 63/126,564, filed on Dec. 17, 2020.
(60) Provisional application No. 63/246,164, filed on Sep. 20, 2021.

(51) Int. Cl. C04B 26/16; C04B 18/16; C04B 14/42; C04B 14/06

(52) U.S. Cl. CPC C04B 26/16; C04B 18/167; C04B 14/42; C04B 14/06; C04B 2111/72

(57) ABSTRACT

A method of pouring a body, including mixing an isocyanate, a polyol, and a catalyst to yield an admixture, dispersing a particulate phase in the admixture to yield a homogeneous composition, pouring the homogeneous composition into a preform, capping the preform to prevent expansion of the homogeneous composition thereoutof, and curing the homogeneous composition to yield a polymeric composite body. The matrix portion is formed from a polymerizable formulation comprising at least one isocyanate precursor, at least one polyol, and a catalyst contained in a mold having a pressure rating of at least 0.4 Mpa. The at least one isocyanate precursor is selected from the group consisting of polymethylene polyphenylisocyanate, diphenylmethane diisocyanate, triphenylmethane triisocyanate, toluene diisocyanate and methyl diisocyanate (MDI), and combinations thereof. The catalyst is selected from the group consisting of a dialkyltin derivative, tributyl bismuth, and combinations thereof and is a tertiary amine.

### CROSS-REFERENCE TO RELATED APPLICATIONS

This application is a continuation-in-part of co-pending U.S. patent application Ser. No. 17/681,707, filed on Feb. 25, 2022, which was a continuation-in-part of co-pending U.S. patent application Ser. No. 17/553,965, filed on Dec. 17, 2021, which claimed the benefit of then co-pending U.S. Provisional Patent Application Ser. No. 63/126,564, filed on Dec. 17, 2020; this application also claims priority to U.S. provisional Patent Application Ser. No. 63/246,164, filed on Sep. 20, 2021; all of which are incorporated by reference herein.

### TECHNICAL FIELD

The novel technology relates generally to the field of materials science and, specifically, to formulations for composite materials enjoying a quick setting polymer matrix with one or more structural phases dispersed therein.

### BACKGROUND

Construction techniques have developed around the use of wood and wood-derived materials. Attachments are commonly made with nails, screws, staples, glue and the like. In addition to having grain-dependent physical properties, wood and wood related materials suffer from the potential of moisture, attack by insects and microorganisms, and destruction by fire. Wood also suffers from set dimensions arising from the solid and fibrous nature of the wood itself, which somewhat limits its utility. What is needed is a structural material having the advantageous properties of a wood-based structural material while lacking the disadvantageous properties of wood, thus allowing for the use of conventional construction techniques, but that also provides versatility of use while providing protection against damage caused by water, fire, insect, and microorganisms. The present disclosure addresses these needs.

### DESCRIPTION OF THE PREFERRED EMBODIMENTS

For the purposes of promoting an understanding of the principles of the invention and presenting its currently understood best mode of operation, reference will now be made to the embodiments illustrated in the specific language will be used to describe the same. It will nevertheless be understood that no limitation of the scope of the invention is thereby intended, with such alterations and further modifications in the illustrated technology and such further applications of the principles of the invention as illustrated therein being contemplated as would normally occur to one skilled in the art to which the invention relates.

For the purpose of assisting with the understanding of the present disclosure, the following definitions are provided:
Isocyanate precursor refers to isocyanate derivatives having two, or more isocyanate groups attached thereto.
Plant fibers refer to fibers derived from a plant material.
A vegetable oil refers to an oil derived from a plant source, or a synthetic mixture simulating a vegetable oil.
Pot life refers to a time between mixing a formulation's components and an expansion of the formulation's volume beyond the mold's volume.
Elastomer refers to components such as for example, butadiene monomer, neoprene, and other synthetic elastomers.

The embodiments discussed below and given in the following examples relate to composite materials, each having a matrix phase and at least one dispersed second phase suspended therein. The matrix phase is a formulation capable of rapidly polymerizing on site without the application of heat to provide relatively lightweight structural materials but with compressive strength, toughness, and wear resistance comparable to structural materials such as concrete, steel, and the like. Formulations for the matrix phase typically include a polymeric isocyanate, a monomeric diisocyante, or mixtures thereof, a polyol, and a catalyst. Formulations can optionally contain fatty acids, fatty acid esters, polyphenols, polyphenolic epoxides, antioxidants (such a hydroxylamine), surfactants, blowing agents, colorants, flame retardants, and plasticizers. Suitable polymeric isocyanates can be provided in their polymeric form or formed in situ, and include polymethylene polyphenylisocyanate, diphenylmethane diisocyanate, triphenylmethane triisocyanate, toluene diisocyanate, and methyl diisocyanate. Preferred isocyanates include the polymeric isocyanate polymethylene polyphenylisocyanate, and the monomeric diisocyanate MDI. Preferred amounts of the polymeric isocyanate (or its monomeric precursor) include from about 20-50 wt. %, more preferably from about 25-45 wt. %, and most preferably from about 30-40 wt. %. Certain polyols include polyolethers and polyesters derived from sucrose, sorbitol, and/or glycerol. Other polyols include polyether polyols, which are ethylene oxide adducts of polyoxypropylene triol. Preferred amounts of the polyol include from about 15-50 wt. %, more preferably from about 20-45 wt. %, and most preferably from about 25-40 wt. %. Suitable catalysts include, but are not limited to, amines such as trimethylhexamethylenediamine, tetramethylbutanediamine, triethylenediamine, and 2-hydroxypropylethylene-diamine, and dialkyl tin derivatives. Preferred amounts of an amine catalyst include from about 3-8 wt. %, more preferably from about 4-7 wt. %, and most preferably from about 5-6 wt. %. Fatty acid and fatty acid esters can be provided by vegetable oil components such as soy oil, olive oil, corn oil and the like. Preferred amounts of a vegetable oil containing fatty acids and fatty acid esters include from about 0.1-10 wt. %, more preferably from about 1-7 wt. %, and most preferably from about 2-6 wt. %.

The dispersed second phase may include Portland cement powder, graphite, graphene, carbon nanotubes, poly-paraphenylene terephthalamide fibers, aramid fibers, polymer fibers, organic fibers (hemp, cotton, and the like), metal powders, metal filings, metal oxides, combinations thereof, and the like. Preferred amounts of dispersed second phase materials range from 1-65 wt. %, more preferably from about 5-40 wt. %, and most preferably from about 15-30 wt. %. In some embodiments, the dispersed second phase is absent.

Suitable polyphenols include 4,4′-isopropylidenediphenol and the like. Suitable surfactants can include polalkylene polysiloxane, dimethyl silicone polymer, and the like. Examples of blowing agents capable of producing a closed cell structure include, but are not limited to, water, fluorocarbons, such as trichloromonofluoromethane, methylene chloride, and the like. Ester such as butyl benzyl phthalate, other phthalate esters and the like can similarly be included to reduce water vapor permeability, reduce cell volume, and increase the number of closed cells.

Polymerizable formulations according to this disclosure can also include polyphenolic epoxides, such as for example the adduct of 4,4′-(1 Methylethylidene) bisphenol polymer with (chloromethyl)oxirane or the components utilized to prepare the adduct.

The matrix phase formulations described hereinabove can be formed at ambient temperatures and handled for about 30-120 seconds before polymerization initiates, and further handled for 1-10 minutes before sealing the mold. Cooling the components prior to and during mixing can lengthen the formulation's pot life. Polymerization of the matrix phase formulation, once initiated, is exothermic, proceeds under substantially adiabatic conditions and is complete within minutes.

The second phase material is added to the matrix phase precursors and is typically homogenously mixed therewith to yield an admixture having a homogeneously dispersed second phase. The second phase is typically provided as a powder or quantity of short (micro-) fibers. The second phase material may be a unitary phase or an admixture.

The presence of the dispersed second phase typically allows for the composite material to achieve enhanced physical properties, such as compressive strength, tensile strength, shear strength, and the like while remaining relatively light weight and often retaining the desirable property of being able to hold nails. The suspended second phase material is typically dispersed homogeneously so that the composite material has isotropic physical and chemical properties; however, it is possible to orient some additive phases, such as fibrous materials, to yield anisotropic properties if so desired.

The composite material remains relatively lightweight, especially when compared to concrete, iron, steel and like structural materials. The composite density ranges from about 0.15 to about 1.2 g/cc, while steel is typically about 8 g/cc and concrete is typically about 2.3 g/cc.

For comparison, steel has a compression strength of about 152 Mpa, a tensile strength of about 345 Mpa, and a shear strength of about 65.5 MPa; concrete has a compression strength of about 24 Mpa, tensile strength of about 3.4 Mpa, and a shear strength of about 5.0 MPa; hard wood has a compression strength of about 58.6 MPa with grain/6.9 MPa against grain, a tensile strength of about 70 MPa with grain/3.4 MPa against grain, and a shear strength of about 12.4 Mpa.

In some cases, the molds used to receive and contain the admixture are made of rigid structural materials and are reinforced with clamps and/or belts, and are typically capable with containing reactions generating 4.0 MPa or greater, often up to 7.0 MPa. These pressure ratings were necessary for early, less refined formulations that would react more quickly and generate higher pressures over shorter periods of time. However, as the process and formulations have become more refined and with the advent of flexible, self-sealing elastomeric mold materials, such a silicone rubber and like polymeric compositions, the molds are typically required to contain pressures between 0.15 and 0.7 MPa, with a pressure rating of 0.4 MPa usually being sufficient. The current silicone rubber or like molds also lend themselves to more intricate detailing and design of the final molded bodies.

### EXAMPLE 1

Example 1 is a composite material wherein a mixture of hemp fibers and fiberglass is homogeneously dispersed in the polymer matrix. Methylene bis(phenylisocyanate) or MDI (11.35 g), polymethylene polyphenylisocyanate (11.35 g), and 2-hydroxypropylethylene-diamine (22.7 g) were combined, along with 4.66 grams ground hemp and 4.66 grams ground HT fiberglass. The mixture was stirred to yield a homogeneous admixture, and the admixture was poured into a mold. The mold was sealed and the admixture was allowed to react therein. Within about 15 minutes the temperature rose to about 54.5° C. and produced an internal pressure of about 0.4 Mpa. Upon removal from the mold, the structural material was waterproof, and could be nailed, sawed, screwed, and sanded. The structural material exhibited compressive strength of about 18.6 Mpa, tensile strength of about 16.9 Mpa, and in-plane shear strength of about 9.3 Mpa. This composite has a density of 0.73 g/cc.

### EXAMPLE 2

Example 2 is a composite material wherein a mixture of alumina and graphene powders is homogeneously dispersed in the polymer matrix. Methylene bis(phenylisocyanate) or MDI (11.4 g), polymethylene polyphenylisocyanate (11.4 g), and 2-hydroxypropylethylene-diamine (22.7 g) were combined, along with 5.7 grams alumina powder and 5.7 grams graphene powder. The mixture was stirred to yield a homogeneous admixture, and the admixture was poured into a mold. The mold was sealed and the admixture was allowed to react therein. Within about 15 minutes the temperature rose to about 54.5° C. and produced an internal pressure of about 0.4 Mpa. Upon removal from the mold, the structural material was waterproof, and could be nailed, sawed, screwed, and sanded. The structural material exhibited compressive strength of about 33.4 Mpa, tensile strength of about 15.4 Mpa, and in-plane shear strength of about 18.1 Mpa. This composite has a density of 0.74 g/cc.

### EXAMPLE 3

Example 3 is a composite material wherein a mixture of stainless steel and graphene powders is homogeneously dispersed in the polymer matrix. Methylene bis(phenylisocyanate) or MDI (10.7 g), polymethylene polyphenylisocyanate (10.7 g), and 2-hydroxypropylethylene-diamine (21.4 g) were combined, along with 22.5 grams 325 mesh stainless steel powder, 2 grams liquid epoxy, and 1.8 grams graphene powder. The mixture was stirred to yield a homogeneous admixture, and the admixture was poured into a mold. The mold was sealed and the admixture was allowed to react therein. Within about 15 minutes the temperature rose to about 54.5° C. and produced an internal pressure of about 0.4 Mpa. Upon removal from the mold, the structural material was waterproof, and could be nailed, sawed, screwed, and sanded. The structural material exhibited compressive strength of about 43.2 Mpa, tensile strength of about 10.0 Mpa, and in-plane shear strength of about 23.9 Mpa. This composite has a density of 0.58 g/cc.

### EXAMPLE 4

Example 4 is a composite material wherein a mixture of polymer fibers and graphene powder is homogeneously dispersed in the polymer matrix. Methylene bis(phenylisocyanate) or MDI (9.2 g), polymethylene polyphenylisocyanate (9.2 g), and 2-hydroxypropylethylene-diamine (18.3 g) were combined, along with 6.8 grams chopped poly(azanediyl-1,4-phenyleneazanediylterephthaloyl) fibers (from 0.6 to 3 cm in length and a few mm thick) with 0.7 grams graphene powder. The mixture was stirred to yield a homogeneous admixture, and the admixture was poured into a mold. The mold was sealed and the admixture was allowed to react therein. Within about 15 minutes the temperature rose to about 54.5° C. and produced an internal pressure of about 0.4 Mpa. Upon removal from the mold, the structural material was waterproof, and could be nailed, sawed, screwed, and sanded. The structural material exhibited compressive strength of about 24.0 Mpa, tensile strength of about 5.6 Mpa, and in-plane shear strength of about 10.5 Mpa. This composite has a density of 1.01 g/cc.

### EXAMPLE 5

Example 5 is a composite material wherein a mixture of cement powder is homogeneously dispersed in the polymer matrix. Methylene bis(phenylisocyanate) or MDI (9.9 g), polymethylene polyphenylisocyanate (9.9 g), and 2-hydroxypropylethylene-diamine (19.8 g) were combined, along with 22.8 grams QUIKRETE powder (QUIKRETE is a registered trademark of Quikrete International, Inc., a Delaware Corporation, 3490 Piedmont Rd. N.E., Ste. 1300 Atlanta, Ga., 30305, Reg. No. 0767386). The mixture was stirred to yield a homogeneous admixture, and the admixture was poured into a mold. The mold was sealed and the admixture was allowed to react therein. Within about 15 minutes the temperature rose to about 54.5° C. and produced an internal pressure of about 0.4 Mpa. Upon removal from the mold, the structural material was waterproof, and could be nailed, sawed, screwed, and sanded. The structural material exhibited compressive strength of about 39.9 Mpa, tensile strength of about 23.6 Mpa, and in-plane shear strength of about 21.3 Mpa. This composite has a density of 0.55 g/cc.

### EXAMPLE 6

Example 6 is a non-homogeneous composite structural member wherein a polymer matrix composite layer is sandwiched between two steel plate members. The polymer matrix material includes a mixture of hemp fibers and fiberglass is homogeneously dispersed in the polymer matrix. Methylene bis(phenylisocyanate) or MDI (113 g), polymethylene polyphenylisocyanate (113 g), and 2-hydroxypropylethylene-diamine (225 g) were combined, along with 40 grams of chopped fiberglass (1-2 cm long) and 50 g chopped hemp fibers (1 cm long). The mixture was stirred to yield a homogeneous admixture. The admixture was poured into a mold already containing a stainless steel plate member (26 gauge steel, 12×3.5 inches) and a second identical stainless steel plate was placed atop the pour. The mold was sealed and the admixture was allowed to react therein. Upon removal from the mold, the polymer matrix filling was adhered to both stainless steel plates. The polymer matrix composite layer exhibits significantly lower thermal and electrical conductivity than the oppositely disposed steel layers. The structural material exhibited compressive strength of about 39.9 Mpa, tensile strength of about 23.6 Mpa, and in-plane shear strength of about 21.3 Mpa. This composite has a density of 1.21 g/cc.

It should be noted that the thickness of the polymer layer between the steel plates may be varied. Successive layers of polymer may be added to yield multilayer steel/polymer composite structures, with multiple steel layers and polymer layers. Typically, the outermost layers are both steel, but one or both may be polymer. Tensile, compressive, and shear strengths of the composite may approach or even exceed that of solid steel, making composite layered structural members, such as I-beams, possible having reduced weight and decreased thermal and electrical conductivity across the layers. The polymer matrix composite layers maybe the same or different compositions, and the physical properties of the polymer matrix composite layers may be tailored to yield specifically desired properties to the structural body so formed.

### EXAMPLE 7

Example 7 is a composite material wherein a mixture of shredded textiles (mostly cotton) is homogeneously dispersed in the polymer matrix. Methylene bis(phenylisocyanate) or MDI (100 g), polymethylene polyphenylisocyanate (100 g), and 2-hydroxypropylethylene-diamine (200 g) were combined, along with 40 grams shredded cotton fabric (strips about 1-3 mm×8-20 mm, along with some residual finer fibers). The mixture was stirred to yield a generally homogeneous admixture, and the admixture was poured into a mold. The mold was sealed and the admixture was allowed to react therein. Within about 15 minutes the temperature rose to about 54.5° C. and produced an internal pressure of about 0.4 Mpa. Upon removal from the mold, the structural material was waterproof, and could be nailed, sawed, screwed, and sanded. The structural material exhibited tensile strength of about 19.8 Mpa. This composite has a density of 0.26 g/cc.

In operation, the novel composite formulations are reacted to polymerize the matrix phase in order to yield the composite structural material having advantageous properties. The formulation's components including dispersed second phase material(s) may be combined and mixed in a serial manner outside of the mold or added directly to the mold with mixing therein. Second phase materials can also be added directly to the mold and subsequently combined and mixed with the matrix phase components added to the mold. The mold utilized should be capable of maintaining elevated pressures such as at least about 0.40 MPa and more preferably at least about 0.14 to 0.55 Mpa. Once the mixed components have all been added to the mold, the mold is closed and secured against the build-up of pressure. This is typically accomplished through the use of clamping devices or hydraulic systems. Components are typically combined at ambient temperature, but may likewise be cooled before combining to delay polymerization, if necessary, for sufficient time to fill and secure the mold. Once the components are combined, mixed, and secured within the mold, polymerization initiates in an exothermic and substantially adiabatic manner causing the polymerization mixture to reach temperatures in the range of about 38 to 77° C., or more preferably within the range of from about 43 to 71° C., and still more preferably within the range of from about 49 to 66° C., and pressures ranging from about 0.10 to 0.70 Mpa, more preferably from about 0.15 to 0.60, and still more preferably from about 0.20 to 0.50 Mpa. Polymerization is completed within about 5 to 35 minutes, more preferably within about 10 to 25 minutes, still more preferably within about 15 to 20 minutes. Upon cooling the newly formed structural material can be removed from the mold and utilized for its intended purpose.

In general, the composite structural material, once formed and molded to a desired shape and comprising a closed foam polyurethane matrix containing a dispersed second phase, exhibits several properties generally associated with wood. For example, the composite structural material may be sawed, accept and retain nails, screws, and staples, is waterproof, resists insect damage, can be sanded, glued and painted, and is self-extinguishing when exposed to a flame. Flame retardant qualities can be further improved by the addition of flame retardants such as tricresyl phosphate.

Examples of items constructed from the structural material include, but are not limited to, board replacements for use in flooring, siding, roofing, stairs, railings, trusses, pallets, carts, containers, water vessels, docks, pre-fabricated emergency housing, panels for semi-trailers and RV's, auto and truck components, acoustical barriers, highway railing & bumpers, and the like; structural elements for framing such as 2×4's, a wall panel; and fencing and deco trim. As can be recognized from the above listing, the structural material can also advantageously replace some metal, ceramic, and concrete articles, and be substituted for other plastic articles. Structural materials can also be mixed polymers such as polyurethanes/epoxides.

### EXAMPLE 8

The polymer matrix material is produced by heterogenous polymerization wherein molecular crosslinking of the polymer composition is controlled through constrained volumetric expansion during the crosslinking process. Example composition is 350 grams—A2-23-025-B1/Diph-Diisocyanate and 350 grams—B-23-025-B1H/Polyol Resin and a catalyst to yield an admixture. Dispersed phases include 50 grams HT fiber, 50 grams fiberglass, 100 grams SiO2, and 200 grams reclaimed concrete aggregate. Expansion is limited by a closed mold, and the resulting composite was homogenous. In general, at least two sides of the polymer admixture need to be restricted to limit expansion. One example use for this material is filling a pothole with the admixture, covering the top to limit expansion, and allowing expanding admixture to infiltrate cracks and voids in the sidewalls of the pothole. Set time is on the order of 20 minutes to an hour, depending on pothole size. Other uses include anchors, in situ poured slabs and foundations, footings, walls, roofing, countertops, cutting surfaces, and the like.

While the novel technology has been illustrated and described in detail in the foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1. A composite material, comprising:
a closed cell polyurethane matrix portion and further comprising:
A2-23-025-B1/diph-diisocyanate;
B-23-025-B1H/polyol resin; and
a particulate portion homogeneously distributed and suspended in the matrix portion;
wherein the particulate portion is selected from the group consisting of HT fiber, fiberglass, SiO2, reclaimed concrete aggregate and combinations thereof;
wherein the composite material has a compressive strength between 14 MPa and 70 MPa;
wherein the composite material has a tensile strength between 5.5 MPa and 70 MPa;
wherein the composite material has a shear strength between 7.0 MPa and 55 MPa; and
wherein the composite material has a density between 0.15 g/cc and 1.2 g/cc.

2. The composite material of claim 1 wherein the composite material has a compressive strength between 17 MPa and 56 MPa;
wherein the composite material has a tensile strength between 7 MPa and 49 MPa;
wherein the composite material has a shear strength between 10 MPa and 42 MPa; and
wherein the composite material has a density between 0.15 g/cc and 1.0 g/cc.

3. A method of repairing a pothole, comprising:
a) mixing A2-23-025-B1/diph-diisocyanate and B-23-025-B1H/polyol resin to yield an admixture;
b) dispersing a particulate phase in the admixture to yield a homogeneous composition; wherein the particulate phase is selected from the group consisting of HT fiber, fiberglass, SiO2, reclaimed concrete aggregate and combinations thereof;
c) filling a pothole with the homogeneous composition, wherein the pothole is defined by an outer boundary;
d) covering at least two sides of the pothole to limit expansion of the homogeneous composition to within the outer boundary;
e) allowing expansion of the homogeneous composition to infiltrate cracks and voids in outer boundary; and
f) curing the homogeneous composition to yield a solid structural material filling the pothole.

4. The method of claim 3, d) includes covering at least two sides and the top of the pothole to limit expansion of the homogeneous composition to within the outer boundary.

5. A method of pouring a body, comprising:
g) mixing an isocyanate, a polyol, and a catalyst to yield an admixture;
h) dispersing a particulate phase in the admixture to yield a homogeneous composition;
i) pouring the homogeneous composition into a preform;
j) capping the preform to prevent expansion of the homogeneous composition thereoutof; and
k) curing the homogeneous composition to yield a polymeric composite body.

6. The method of claim 5 wherein the matrix portion is formed from a polymerizable formulation comprising at least one isocyanate precursor, at least one polyol, and a catalyst contained in a mold having a pressure rating of at least 0.4 Mpa.

7. The method of claim 6 wherein the at least one isocyanate precursor is selected from the group consisting of polymethylene polyphenylisocyanate, diphenylmethane diisocyanate, triphenylmethane triisocyanate, toluene diisocyanate and methyl diisocyanate (MDI), and combinations thereof, wherein the catalyst is selected from the group consisting of a dialkyltin derivative, tributyl bismuth, and combinations thereof; and wherein the catalyst is a tertiary amine.

8. The method of claim 7 wherein the particulate phase is selected from the group consisting of HT fiber, fiberglass, SiO2, reclaimed concrete aggregate, and combinations thereof.

9. The method of claim 7 wherein the particulate phase is selected from the group consisting of hemp fiber, textile fibers, cotton fibers, textile strips, poly(azanediyl-1,4-phenyleneazanediylterephthaloyl) fiber, graphene, graphite, carbon nanotubes, alumina, silica, Portland cement, aluminum powder, steel powder, iron powder, iron filings, copper powder, tungsten carbide, boron nitride, diamond, amorphous carbon, and combinations thereof.

10. The method of claim 7 wherein the particulate phase is selected from the group consisting of wherein the second phase portion is selected from the group consisting of fiberglass, hemp fiber, textile fibers, cotton fibers, textile strips, poly(azanediyl-1,4-phenyleneazanediylterephthaloyl) fiber, graphene, graphite, carbon nanotubes, alumina, silica, talc, Portland cement, aluminum powder, steel powder, iron powder, iron filings, copper powder, tungsten carbide, boron nitride, diamond, amorphous carbon, shredded tires, and combinations thereof.

11. The method of claim 8 wherein the preform defines a member of the group consisting of a slab, an anchor, a foundation, a footing, a wall, and roofing.

12. The method of claim 9 wherein the preform defines a member of the group consisting of a slab, an anchor, a foundation, a footing, a wall, and roofing.

13. The method of claim 10 wherein the preform defines a member of the group consisting of a slab, an anchor, a foundation, a footing, a wall, and roofing.

14. A method for forming a structural material including:
a) providing a formulation consisting of at least one isocyanate, a polyol, and a catalyst contained in a mold having a pressure rating of at least 0.4 Mpa;
b) sealing the mold within about 1 to 10 minutes after step a;
c) polymerizing the formulation in an exothermic and adiabatic manner until complete as evidenced by no further generation of heat.

15. The method of claim 14, wherein the step of polymerizing is complete within about 5 to 25 minutes.

16. The method of claim 14, wherein the step of polymerizing results in a pressure within the mold of about 0.15 to 0.7 Mpa.

17. The method of claim 14, wherein the t least one isocyanate is selected from the group consisting of polymethylene polyphenylisocyanate, diphenylmethane diisocyanate, triphenylmethane triisocyanate, toluene diisocyanate and methyl diisocyanate (MDI), and combinations thereof; wherein the catalyst is selected from the group consisting of a dialkyltin derivative, tributyl bismuth, and combinations thereof; and wherein the catalyst is a tertiary amine.

18. The method of claim 17 and further including the step of after a) and before b), dispersing a second phase into the admixture; wherein the second phase is selected from the group comprising fiberglass, hemp fiber, textile fibers, cotton fibers, textile strips, poly(azanediyl-1,4-phenyleneazanediylterephthaloyl) fiber, graphene, graphite, carbon nanotubes, alumina, silica, talc, Portland cement, aluminum powder, steel powder, iron powder, iron filings, copper powder, tungsten carbide, boron nitride, diamond, amorphous carbon, shredded tires, concrete aggregate, and combinations thereof.
